(19) United States
(12) Patent Application Publication
(10) Pub. No.: US 2007/0146756 A1
(43) Pub. Date: Jun. 28, 2007

(54) Method of operating an imaging apparatus having a duplexer and a perforation device

(76) Inventors: Adam Jude Ahne, Lexington, KY (US); Mark Joseph Edwards, Lexington, KY (US); Brian Keith Owens, Lexington, KY (US); Ricky Earl Robbins, Harrodsburg, KY (US); Ronald Todd Sellers, Stamping Ground, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/320,222

(22) Filed: Dec. 28, 2005

(51) Int. Cl. G06K 15/00

(52) U.S. Cl. 358/1.12

(57) ABSTRACT

A method of operating an imaging apparatus having a duplexer and a perforation device for processing a sheet of media having a first surface and a second surface opposite to the first surface includes forming an image on the first surface of the sheet of media; advancing the sheet of media through the duplexer; and forming a plurality of close-spaced perforations on the sheet of media from the second surface toward the first surface.

### BACKGROUND OF THE INVENTION

1. Field of the invention.

The present invention relates to an imaging apparatus, and, more particularly, to a method of operating an imaging apparatus having a duplexer and a perforation device.

2. Description of the related art.

A typical imaging apparatus, such as a printer or an All-In-One machine (AIO), includes a print engine for forming an image on one or more sheets of media, such as paper, using ink and/or toner. Such a print engine may be, for example, an ink jet print engine having a reciprocating printhead carrier carrying one or more replaceable printhead cartridges, or an electrophotographic (e.g., laser) print engine. An AIO, also sometimes referred to as a multifunction device (MFD), is configured to perform stand alone functions, and in addition to a print engine, typically includes a scanner for performing copying or facsimile transmission. The AIO may be connected to a host computer via a communications link to facilitate a printing function. Some AIOs or printers may further include a mechanical duplexer that is used to flip the sheet of media to enable printing on either or both sides of the sheet of media.

Various devices are available for performing perforation and/or cutting operations. However, many such devices are used in commercial applications, and are generally cost prohibitive to lower volume users. Also, such devices are often standalone devices, requiring the purchase of additional hardware. Some efforts have been directed to incorporating a perforation device into an imaging apparatus so as to facilitate both printing and perforating with the same imaging apparatus.

### SUMMARY OF THE INVENTION

The invention, in one form thereof, is directed to a method of operating an imaging apparatus having a duplexer and a perforation device for processing a sheet of media having a first surface and a second surface opposite to the first surface. The method includes forming an image on the first surface of the sheet of media; advancing the sheet of media through the duplexer; and forming a plurality of close-spaced perforations on the sheet of media from the second surface toward the first surface.

The invention, in one exemplary embodiment, is directed to an imaging apparatus for processing a sheet of media having a first surface and a second surface opposite to the first surface. The imaging apparatus includes a printing apparatus for printing on at least one surface of the sheet of media, a perforator apparatus, a duplexer, and a controller. The controller is communicatively coupled to the printing apparatus, the perforator apparatus and the duplexer. The controller executes program instructions to perform the acts of forming an image on the first surface of the sheet of media with the printing apparatus; advancing the sheet of media through the duplexer; and forming a plurality of close-spaced perforations on the sheet of media from the second surface toward the first surface with the perforator apparatus.

The invention, in another form thereof, is directed to a method of operating an imaging apparatus having a duplexer and a perforation apparatus for processing a sheet of media having a first surface and a second surface opposite to the first surface. The method includes forming an image on the first surface of the sheet of media; advancing the sheet of media through the duplexer; and forming a plurality of perforations on the sheet of media from the second surface toward the first surface around the image.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of a system embodying the present invention.

FIG. 2A illustrates a sheet of media having a first surface and a second surface, with an image formed on the first surface.

FIG. 2B illustrates the sheet of media of FIG. 2A being inverted by a duplexer after the image was formed of the first surface.

FIG. 2C illustrates the perforating of the sheet of media of FIG. 2A from the second surface toward the first surface.

FIG. 3 is a flowchart of a method of operating the imaging apparatus of FIG. 1 for processing a sheet of media in accordance with an embodiment of the present invention.

Corresponding reference characters indicate corresponding parts throughout the several views. The exemplifications set out herein illustrate embodiments of the invention, in one form, and such exemplifications are not to be construed as limiting the scope of the invention in any manner.

### DETAILED DESCRIPTION OF THE INVENTION

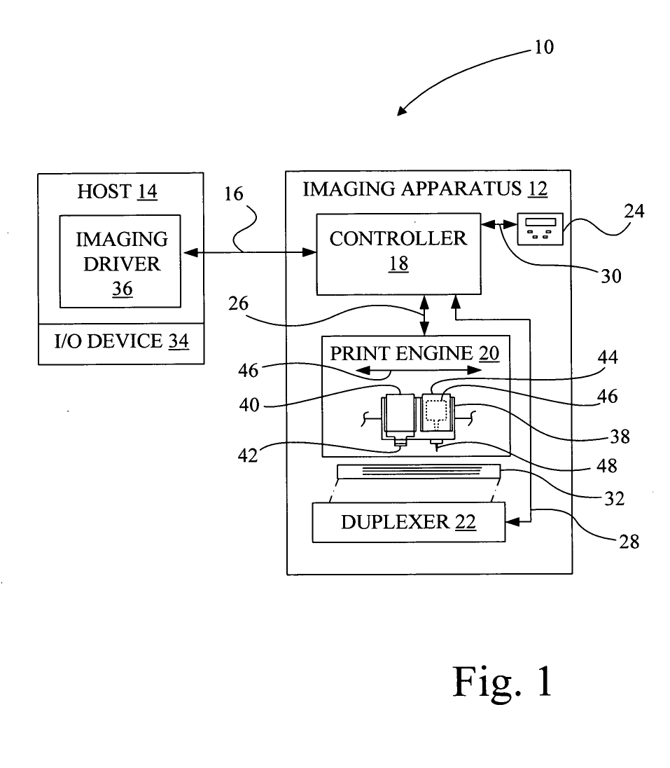

Referring now to the drawings and particularly to FIG. 1, there is shown a diagrammatic depiction of an imaging system 10. Imaging system 10 may include an imaging apparatus 12 and a host 14, with imaging apparatus 12 communicating with host 14 via a communications link 16.

Imaging apparatus 12 may be configured to communicate with host 14 via a standard communication protocol, such as for example, universal serial bus (USB) or Ethernet. As used herein, the term “communications link” is used to generally refer to structure that facilitates electronic communication between two components, and may operate using wired or wireless technology. Communications link 16 may be established, for example, by a direct cable connection, wireless connection or by a network connection such as for example an Ethernet local area network (LAN).

Alternatively, imaging apparatus 12 may be a standalone unit that is not communicatively linked to a host, such as host 14. For example, imaging apparatus 12 may take the form of a multifunction machine, e.g., an all-in-one (AIO) device, which includes standalone copying and facsimile capabilities, in addition to optionally serving as a printer when attached to a host, such as host 14. Imaging apparatus 12 includes, for example, a controller 18, a print engine 20, a duplexer 22 and a user interface 24.

Controller 18 includes a processor unit and associated memory, and may be formed as an Application Specific Integrated Circuit (ASIC). Controller 18 communicates with print engine 20 via a communications link 26. Controller 18 communicates with duplexer 22 via a communications link 28. Controller 18 communicates with user interface 24 via a communications link 30. Communications links 26, 28 and 30 may be established, for example, by using standard electrical cabling or bus structures, or by wireless connection.

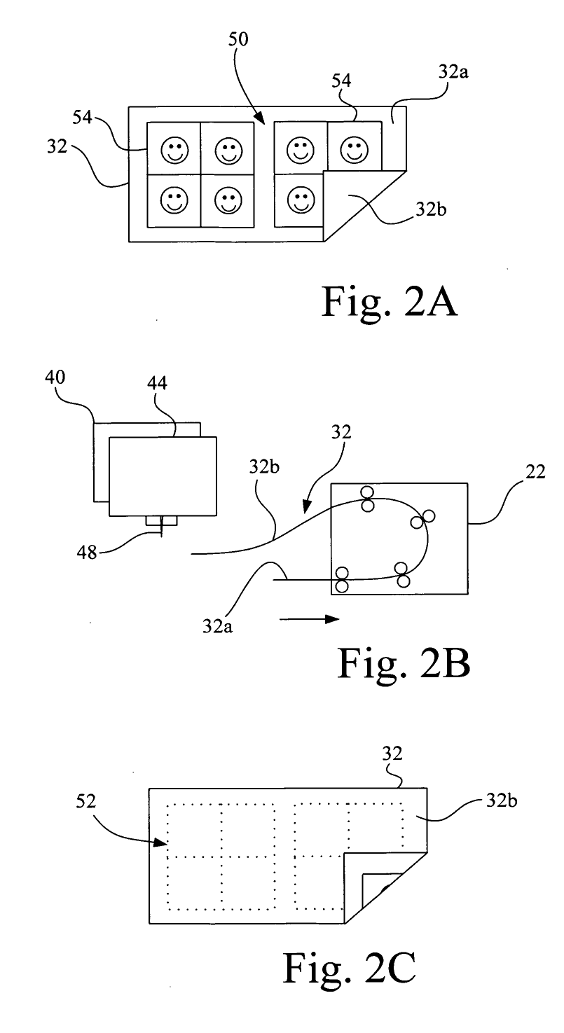

In the context of the examples for imaging apparatus 12 given above, print engine 20 may be, for example, an ink jet print engine configured for forming an image on a sheet of media 32, such as a sheet of paper, transparency, etc. As illustrated in FIG. 2A, the sheet of media 32 has a first surface 32a, e.g., a front side, and a second surface 32b, e.g., a back side, opposite to the first surface 32a. As an ink jet print engine, for example, print engine 20 operates one or more printing cartridges and/or printheads to eject ink droplets onto one of the surfaces of the sheet of media 32 in order to reproduce text and/or images.

Host 14 may be, for example, a personal computer including an input/output (I/O) device 34, such as a keyboard and display monitor. Host 14 further includes a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 36, e.g., driver software for imaging apparatus 12. Imaging driver 36 is in communication with controller 18 of imaging apparatus 12 via communications link 16. Imaging driver 36 facilitates communication between imaging apparatus 12 and host 14, and may provide formatted print data, as determined by a selected print mode, to imaging apparatus 12, and more particularly, to print engine 20, and may provide perforation data to a perforation apparatus, if so equipped.

Alternatively, however, all or a portion of imaging driver 36 may be located in controller 18 of imaging apparatus 12. In one embodiment, for example, where imaging apparatus 12 is a multifunction machine having standalone capabilities, controller 18 of imaging apparatus 12 may include an imaging driver configured to support a scanning and/or copying function using a scanner (not shown), and/or a fax-print function, and may be further configured to support a printer function.

Print engine 20 may include, for example, a reciprocating cartridge carrier 38 for mounting one or more of an ink jet printhead cartridge 40, such as a monochrome, color, and/or photo printhead cartridge. Each such ink jet printhead cartridge 40 includes at least one ink jet printhead 42. Each ink jet printhead 42 includes a plurality of nozzles and associated electrical actuators for selectively ejecting drops of ink at the directive of controller 18. Each ink jet printhead 42 is electrically connected to controller 18 via communications link 26.

Cartridge carrier 38 may be further configured to carry a perforator apparatus 44, e.g., in the form of a perforator cartridge 44. Perforator cartridge 44, for example, may be sized and configured to be mechanically and electrically compatible with the configuration of ink jet printhead cartridge 40 so as to be interchangeable therewith in cartridge carrier 38. Perforator cartridge 44 includes a perforator mechanism 46 coupled to at least one perforation device 48, which may include one or more reciprocating needles or blades, used in forming perforations in the sheet of media 32. Perforator mechanism 46 includes a drive module for driving perforation device 48 in a reciprocating manner, and an electronics module for facilitating communications with controller 18. Perforator mechanism 46 is electrically connected to controller 18 via communications link 26.

Duplexer 22 is operated under the control of controller 18 via communication link 28. Duplexer 22 is typical of that known in the art, and may include a C-shaped paper path and a controllable diverter for directing the sheet of media 32 back through print engine 20 after the sheet of media 32 has been inverted, i.e., flipped, front-to-back.

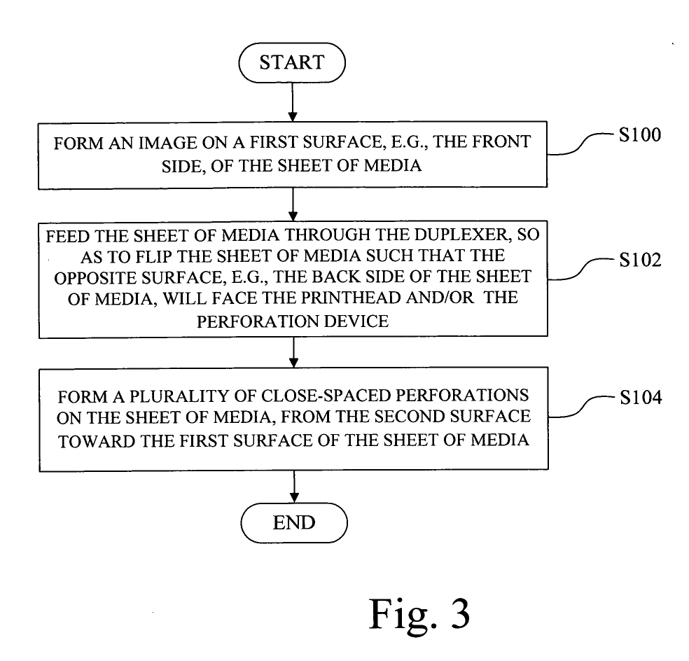

FIG. 3 is a flowchart of a method of operating imaging apparatus 12 for processing a sheet of media, such as the sheet of media 32, in accordance with an embodiment of the present invention. The method may be implemented, for example, by program instructions executing on controller 18 of imaging apparatus 12, or alternatively, by program instructions executing on a controller, e.g., including imaging driver 36, of host 14.

At step S100, an image 50 is formed on the first surface 32a, e.g., the front side, of the sheet of media 32, as illustrated in FIG. 2A. Image 50 may be, for example, one or more pictures, e.g., one or more normal sized photos, or a plurality of thumbnail pictures, and may be formed as a standard or an edge-to-edge image. Image 50 may be formed, for example, by print engine 20, and more particularly, by the selective ejections of ink drops from ink jet printhead cartridge 40 under the control of controller 18.

At step S102, the sheet of media 32 is fed through duplexer 22 so as to invert, i.e., flip, the sheet of media 32 such that the opposite surface 32b, e.g., the back side of the sheet of media 32, will face ink jet printhead 42 of ink jet printhead cartridge 40 and/or perforation device 48 of perforator apparatus 44, as illustrated in FIG. 2B.

At step S104, a plurality of close-spaced perforations 52 are formed on the sheet of media 32, from the second surface 32b toward the first surface 32a of the sheet of media 32, as illustrated in FIG. 2C. The plurality of close-spaced perforations 52 may have a spacing, for example, of 2 millimeters (mm) or less. The plurality of close-spaced perforations 52 may be formed as a continuous perforation line, such as for example, across a width of the sheet of media 32 or around each image 50, such as for example, along a border 54 of each picture in image(s) 50. Also, the plurality of close-spaced perforations 52 may be used to form Braille objects.

Accordingly, the present invention suppresses the perforation operation prior to duplexing. As a result of using the method described above, problems associated with feeding a perforated sheet through the duplexer, which can cause serious paper jams because the perforations weaken and warp the media, is avoided.

The perforation suppression may be done electrically, mechanically or via firmware/software operating on controller 18. For example, the firmware/software may be used to suppress the perforation operation of perforator apparatus 44 on any sheet of media that is destined to be processed through duplexer 22. The firmware may also record a desired perforation design for the first side of the page, then invert that design and perform the perforations on the sheet of media, e.g., the sheet of media 32, after it has been processes through duplexer 22 and inverted. Electrical suppression may consist, for example, of removing power to the perforator apparatus 44 until a given sheet of media has passed through duplexer 22. Mechanical perforator suppression may consist, for example, of increasing the distance between the sheet of media 32 and perforator apparatus 44 such that the perforation device 48, e.g., needles, does not reach the sheet of media 32 before the sheet has passed through duplexer 22.

One example for the use of the above-described method is to form an edge-to-edge image on a sheet of media, such as the sheet of media 32. The traditional method of duplexing a page on a typical printer or AIO is to print the first side of the page, retain the bottom portion of the page in the feed roller, then reverse the feed roller to bring the page into the mechanical duplexer to invert it. This presents a problem when the user would like to duplex a job that is to be printed edge-to-edge, such as photographs. With the present invention the first surface 32a of the sheet of media 32 is printed in the traditional manner with a white margin remaining on the bottom of the page, allowing it to reverse into duplexer 22. Once the sheet of media 32 is inverted and the second surface 32b is printed, perforator apparatus 44 is then engaged to automatically perforate between the printed image and the white margin remaining on the bottom of the sheet of media 32. Once the perforated section is removed, the result is a duplexed image that is printed edge-to-edge on all four sides of the sheet of media 32. In contrast, the sheet of media may be difficult to feed back through duplexer 22 if the page wide perforation is added before duplexing because the sheet of media will naturally fold along the perforation.

Another example of use of the present invention is to use perforator apparatus 44 form Braille objects. With the present invention, a printed image may be formed on a first surface of a transparency and perforator apparatus 44 may emboss the transparency to form the Braille objects from the opposite side after the transparency has passed through duplexer 22.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of operating an imaging apparatus having a duplexer and a perforation apparatus for processing a sheet of media having a first surface and a second surface opposite to said first surface, comprising:
forming an image on said first surface of said sheet of media;
advancing said sheet of media through said duplexer; and
forming a plurality of close-spaced perforations on said sheet of media from said second surface toward said first surface.

2. The method of claim 1, wherein said plurality of close-spaced perforations form a continuous perforation line.

3. The method of claim 2, wherein said image is an edge-to-edge image.

4. The method of claim 1, wherein said plurality of close-spaced perforations has a spacing of 2 mm or less.

5. The method of claim 1, wherein said plurality of close-spaced perforations is formed around said image.

6. The method of claim 1, wherein said plurality of close-spaced perforations form Braille objects.

7. The method of claim 1, wherein a perforation operation performed by said perforator apparatus for forming said close-spaced perforations is suppressed until after said sheet of media has passed through said duplexer.

8. The method of claim 7, further comprising:
recording a desired perforation design for said first surface of said sheet of media; and
inverting said perforation design prior to forming said plurality of close-spaced perforations on said sheet of media from said second surface toward said first surface.

9. An imaging apparatus for processing a sheet of media having a first surface and a second surface opposite to said first surface, comprising:
a printing apparatus for printing on at least one surface of said sheet of media;
a perforator apparatus;
a duplexer;
and a controller communicatively coupled to said printing apparatus, said perforator apparatus and said duplexer, said controller executing program instructions to perform the acts of:
forming an image on said first surface of said sheet of media with said printing apparatus;
advancing said sheet of media through said duplexer; and
forming a plurality of close-spaced perforations on said sheet of media from said second surface toward said first surface with said perforator apparatus.

10. The apparatus of claim 9, wherein said plurality of close-spaced perforations form a continuous perforation line.

11. The apparatus of claim 10, wherein said image is an edge-to-edge image.

12. The apparatus of claim 9, wherein said plurality of close-spaced perforations has a spacing of 2 mm or less.

13. The apparatus of claim 9, wherein said plurality of close-spaced perforations is formed around said image.

14. The apparatus of claim 9, wherein said plurality of close-spaced perforations form Braille objects.

15. The apparatus of claim 9, wherein a perforation operation performed by said perforator apparatus for forming said close-spaced perforations is suppressed until after said sheet of media has passed through said duplexer.

16. The apparatus of claim 15, further comprising one of said controller and a host executing program instructions to perform the acts of:
recording a desired perforation design for said first surface of said sheet of media; and
inverting said perforation design prior to forming said plurality of close-spaced perforations on said sheet of media from said second surface toward said first surface.

17. A method of operating an imaging apparatus having a duplexer and a perforation apparatus for processing a sheet of media having a first surface and a second surface opposite to said first surface, comprising:
forming an image on said first surface of said sheet of media;
advancing said sheet of media through said duplexer; and
forming a plurality of perforations on said sheet of media from said second surface toward said first surface around said image.

18. The method of claim 17, wherein said plurality of perforations form a continuous perforation line.

19. The method of claim 18, wherein said image includes a plurality of pictures, said plurality of perforations being formed on a border of each picture of said plurality of pictures.

20. The method of claim 17, wherein said plurality of perforations has a spacing of 2 mm or less.
